(19) United States
(12) Patent Application Publication
(10) Pub. No.: US 2017/0348638 A1
(43) Pub. Date: Dec. 7, 2017

(54) SYSTEM AND METHOD OF REDUCING OXYGEN CONCENTRATION IN AN EXHAUST GAS STREAM

(71) Applicant: General Electric Company, Schenectady, NY (US)

(72) Inventors: Anthony Herbert Neumayer, Oklahoma City, OK (US); Joseph Philip DiPietro, Oklahoma City, OK (US); William Collins Vining, Highland Park, NJ (US)

(21) Appl. No.: 15/671,256

(22) Filed: Aug. 8, 2017

Related U.S. Application Data
(63) Continuation-in-part of application No. 15/171,775, filed on Jun. 2, 2016.

(51) Int. Cl. B01D 53/90

(52) U.S. Cl. CPC B01D 53/90; B01D 2257/708; B01D 2257/50; B01D 2251/208; B01D 2257/104; B01D 2257/40

(57) ABSTRACT

An oxygen scavenging system that includes a first catalytic converter unit configured to receive an exhaust stream from a power production unit. The exhaust stream includes oxygen. The system also includes a hydrocarbon injection unit configured to channel a hydrocarbon stream for injection into the exhaust stream upstream from the first catalytic converter unit such that hydrocarbons from the hydrocarbon stream react with the oxygen from the exhaust stream within the first catalytic converter unit.

### CROSS-REFERENCE TO RELATED APPLICATIONS

This application is a continuation-in-part and claims priority to U.S. patent application Ser. No. 15/171,775, filed Jun. 2, 2016 for “SYSTEM AND METHOD OF RECOVERING CARBON DIOXIDE FROM AN EXHAUST GAS STREAM”, which is incorporated by reference herein in its entirety.

### BACKGROUND

The present disclosure relates generally to reducing emissions from power plant exhaust and, more specifically, to systems and methods of reducing emissions by scavenging oxygen from an exhaust gas stream.

Power generating processes that are based on combustion of carbon-containing fuel produce carbon dioxide as a byproduct. Typically, the carbon dioxide is one component of a mixture of gases that results from, or passes unchanged through, the combustion process. It may be desirable to capture or otherwise remove the carbon dioxide and other components of the gas mixture to prevent the release of the carbon dioxide and other components into the environment or to use the carbon dioxide for industrial purposes.

To achieve complete combustion of fuel some amount of air or oxygen in excess of stoichiometric is charged to the combustion chamber. The excess oxygen is contained in the exhaust gas. The oxygen concentration in the mixture of gases resulting from the combustion process is typically controlled, or reduced, when carbon dioxide is intended for use in industrial applications. One known method of scavenging oxygen in an exhaust gas stream is in cryogenic distillation separation process. However, the equipment used to facilitate cryogenic distillation typically has a large physical footprint and may require a significant capital investment to implement.

### BRIEF DESCRIPTION

In one aspect, an oxygen scavenging system is provided. The system includes a first catalytic converter unit configured to receive an exhaust stream from a power production unit. The exhaust stream includes oxygen. The system also includes a hydrocarbon injection unit configured to channel a hydrocarbon stream for injection into the exhaust stream upstream from the first catalytic converter unit such that hydrocarbons from the hydrocarbon stream react with the oxygen from the exhaust stream within the first catalytic converter unit.

In another aspect, a method of reducing oxygen concentration in an exhaust stream is provided. The method includes channeling an exhaust stream towards a first catalytic converter unit. The exhaust stream includes oxygen. The method further includes injecting a hydrocarbon stream into the exhaust stream upstream from the first catalytic converter unit such that a mixed exhaust stream is formed, and channeling the mixed exhaust stream into the first catalytic converter unit such that hydrocarbons from the hydrocarbon stream react with the oxygen from the exhaust stream.

In yet another aspect, an oxygen scavenging system is provided. The system includes a first catalytic converter unit configured to receive an exhaust stream from a power production unit, wherein the exhaust stream includes oxygen. A second catalytic converter unit is positioned downstream from the first catalytic converter unit, wherein the second catalytic converter unit is configured to receive a treated exhaust stream discharged from the first catalytic converter unit. A hydrocarbon injection unit is configured to channel a hydrocarbon stream for injection into the treated exhaust stream upstream from the second catalytic converter unit such that hydrocarbons from the hydrocarbon stream react with the oxygen from the treated exhaust stream within the second catalytic converter unit.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an exemplary system for use in recovering carbon dioxide from an exhaust gas stream;

FIG. 2 is a schematic diagram of an alternative system for use in recovering carbon dioxide from the exhaust gas stream;

FIG. 3 is a schematic diagram of another alternative system for use in recovering carbon dioxide from the exhaust gas stream;

FIG. 4 is a perspective view of a transport apparatus;

FIG. 5 is a schematic diagram of an exemplary scavenging system for use in scavenging oxygen from the exhaust gas stream shown in FIG. 1; and

FIG. 6 is a schematic diagram of an alternative scavenging system for use in scavenging oxygen from the exhaust gas stream shown in FIG. 1.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

Embodiments of the present disclosure relate to systems and methods of reducing emissions by recovering carbon dioxide from an exhaust gas stream. In the exemplary embodiment, a turboexpander compresses the exhaust gas stream and a carbon dioxide membrane selectively removes carbon dioxide from the compressed exhaust gas stream. More specifically, the exhaust gas stream is produced by a power generation unit and is received by a first heat exchanger configured to exchange heat between the exhaust gas stream and a lean carbon dioxide stream. The cooled exhaust gas stream is compressed by a compressor which is driven by a turbine as part of a turboexpander. The compressed exhaust gas stream is channeled to the carbon dioxide membrane which selectively removes carbon dioxide from the compressed exhaust gas stream to produce the lean carbon dioxide stream and a rich carbon dioxide stream. The rich carbon dioxide stream is channeled to a cryogenic separation unit which further refines the rich carbon dioxide stream into a carbon dioxide product stream. The lean carbon dioxide stream is channeled to the first heat exchanger to recover energy from the exhaust gas stream. The lean carbon dioxide stream is channeled to the turbine where it is expanded and drives the compressor. The energy recovered from the exhaust gas stream by the lean carbon dioxide stream is used to drive the compressor in the turboexpander. Using the recovered energy to drive the compression needed to separate carbon dioxide from the exhaust gas stream reduces the energy consumption (kilowatt-hour (kWh) (British Thermal Unit (BTU))) per unit mass (kilogram (kg) (pound (lb))) of carbon dioxide recovered of the process. As such, the systems and methods described herein embody the process changes and equipment for use in recovering carbon dioxide from a carbon dioxide-rich gas stream using a carbon dioxide membrane and a turboexpander to reduce the energy consumption per unit of carbon dioxide recovered of the process. The system and methods described herein reduces energy consumption per unit mass of carbon dioxide recovered by 0.33 kWh/kg (510.75 BTU/lb). The system and methods described herein also reduces the capital cost of the system by 15 percent to 30 percent because an engine or motor is no longer needed to drive the exhaust gas compressor.

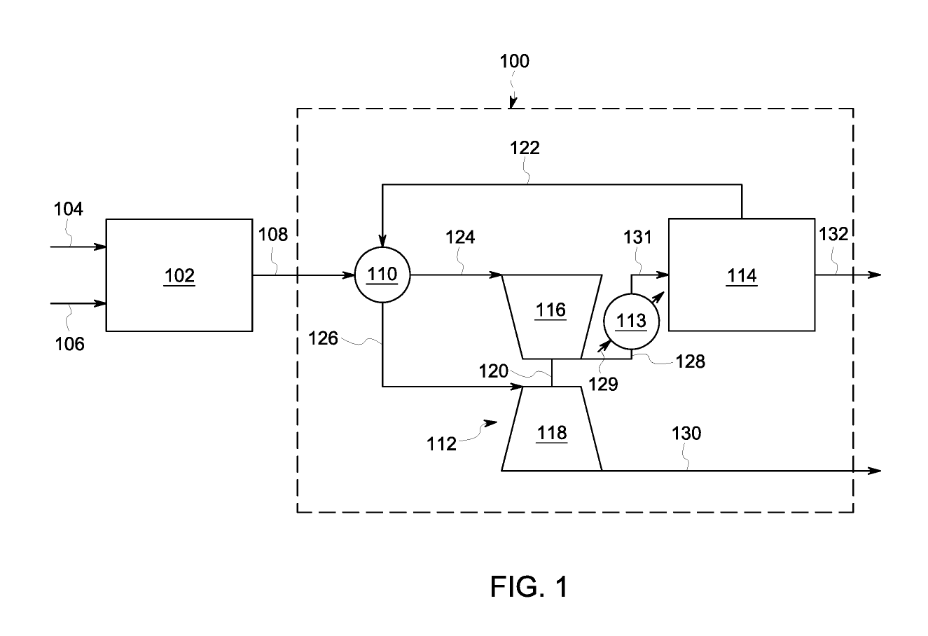

FIG. 1 is a schematic diagram of an exemplary recovery system 100 for use in recovering carbon dioxide from an exhaust gas stream. In the exemplary embodiment, a power production unit 102 is coupled in flow communication with recovery system 100. Non-limiting examples of power production unit 102 include internal combustion engines, gas turbine engines, gasifiers, landfills which produce energy through combustion, furnaces (e.g., blast furnaces or chemical reduction furnaces), steam generators, rich burn reciprocating engines, simple cycle combustion turbines with exhaust gas recycle, boilers, combinations including at least two of the foregoing examples, or any other unit which produces energy by combustion. In one embodiment, power production unit 102 includes a reciprocating engine at a gas pipeline booster station. In another embodiment, power production unit 102 includes a portable power production generator.

Power production unit 102 receives fuel from a fuel stream 104. Fuel stream 104 delivers a carbon rich fuel to power production unit 102. Non-limiting examples of a carbon rich fuel delivered by fuel stream 104 include natural gas, liquefied natural gas, gasoline, jet fuel, coal, or any other carbon rich fuel that enables power production unit 102 to function as described herein. Power production unit 102 receives air from an air stream 106. Power production unit 102 oxidizes fuel from fuel stream 104 with oxygen from air stream 106 to produce electricity and an exhaust gas stream 108. Oxidation of carbon rich fuels produces, among many other byproducts, water and carbon dioxide. Exhaust gas stream 108 generally includes about 12 percent by volume carbon dioxide. However, exhaust gas stream 108 may include a range of concentrations of carbon dioxide ranging from about 7 percent by volume to about 15 percent by volume. Additionally, the temperature of exhaust gas stream 108 is generally 500 degrees Celsius (° C.) (932 degrees Fahrenheit (° F.)) or higher. However, the temperature of exhaust gas stream 108 may include any temperature which enables recovery system 100 to operate as described herein. The high concentration of carbon dioxide in exhaust gas stream 108 enables membrane separation of the carbon dioxide from the rest of exhaust gas stream 108. Additionally, the high temperature of exhaust gas stream 108 provides thermal energy to drive a turboexpander. Carbon dioxide is useful for other industrial applications such as, but not limited to, enhanced oil recovery, tight oil and gas fracturing, hydrogen production, ammonia production and fermentation. Recovery system 100 captures exhaust gas carbon dioxide for use in other industrial applications.

Recovery system 100 includes a first heat exchanger 110, a turboexpander 112, a second heat exchanger 113, and a carbon dioxide membrane unit 114. Turboexpander 112 includes a compressor 116 drivingly coupled to a turbine 118 by a shaft 120. Compressor 116 is a centrifugal compressor driven by turbine 118 through shaft 120. First heat exchanger 110 is coupled in flow communication with power production unit 102, carbon dioxide membrane unit 114, compressor 116, and turbine 118. Second heat exchanger 113 is coupled in flow communication with carbon dioxide membrane unit 114, compressor 116, and a cooling water system (not shown). First and second heat exchangers 110 and 113 are configured to exchange heat between two streams. Non-limiting examples of first and second heat exchangers 110 and 113 include shell and tube heat exchangers, plate and frame heat exchangers, or any other heat exchanger which enables first and second heat exchangers 110 and 113 to function as described herein. Turbine 118 and carbon dioxide membrane unit 114 both produce product streams.

During operation, first heat exchanger 110 receives exhaust gas stream 108 from power production unit 102 and a lean carbon dioxide stream 122 from carbon dioxide membrane unit 114. First heat exchanger 110 exchanges heat between exhaust gas stream 108 and lean carbon dioxide stream 122. Exhaust gas stream 108 is reduced in temperature to produce a cooled exhaust gas stream 124 and lean carbon dioxide stream 122 is increased in temperature to produce a heated lean carbon dioxide stream 126. Compressor 116 and carbon dioxide membrane unit 114 require the temperature of exhaust gas stream 108 to be reduced to operate safely. As such, first heat exchanger 110 recovers energy from exhaust gas stream 108 and protects compressor 116 and carbon dioxide membrane unit 114. During cooling, some water entrained in exhaust gas stream 108 may separate from exhaust gas stream 108 by condensation. In the exemplary embodiment, the concentration of carbon dioxide in cooled exhaust gas stream 124 after water has condensed out of the stream is about 14 percent by volume.

Compressor 116 receives cooled exhaust gas stream 124 from first heat exchanger 110. The pressure of cooled exhaust gas stream 124 is atmospheric pressure or approximately 101 kilopascals absolute (kPa) (14.7 pounds per square inch absolute (psia)). Carbon dioxide membrane unit 114 requires an increased pressure to selectively remove carbon dioxide. In the exemplary embodiment, carbon dioxide membrane unit 114 requires the pressure of cooled exhaust gas stream 124 to be increase to approximately 483 kPa (70 psia). Compressor 116 compresses cooled exhaust gas stream 124 to approximately 483 kPa (70 psia) to produce a compressed exhaust gas stream 128.

Turbine 118 receives heated lean carbon dioxide stream 126 from first heat exchanger 110. Turbine 118 expands heated lean carbon dioxide stream 126 and rotates shaft 120. Shaft 120, in turn, rotates compressor 116 and compresses cooled exhaust gas stream 124. As such, turbine 118 recovers the energy recovered from exhaust gas stream 108 and uses the recovered energy to power compressor 116. Using recovered energy to power compressor 116 saves energy and reduces the energy consumption per unit of carbon dioxide recovered by recovery system 100. Turbine 118 produces an expanded lean carbon dioxide stream 130 which is discharged to the atmosphere.

Second heat exchanger 113 receives compressed exhaust gas stream 128 from compressor 116. Second heat exchanger 113 exchanges heat between compressed exhaust gas stream 128 and a cooling fluid 129. In the exemplary embodiment, cooling fluid 129 includes cooling water from a cooling water system (not shown). Cooling fluid 129 may be any fluid which enables recovery system 100 to function as described herein. Compressed exhaust gas stream 128 is reduced in temperature to produce a cooled compressed exhaust gas stream 131. During compression, the heat of compression from compressor 116 increases the temperature of compressed exhaust gas stream 128. Carbon dioxide membrane unit 114 requires the temperature of compressed exhaust gas stream 128 to be reduced to operate safely. As such, second heat exchanger 113 cools compressed exhaust gas stream 128 to protect carbon dioxide membrane unit 114.

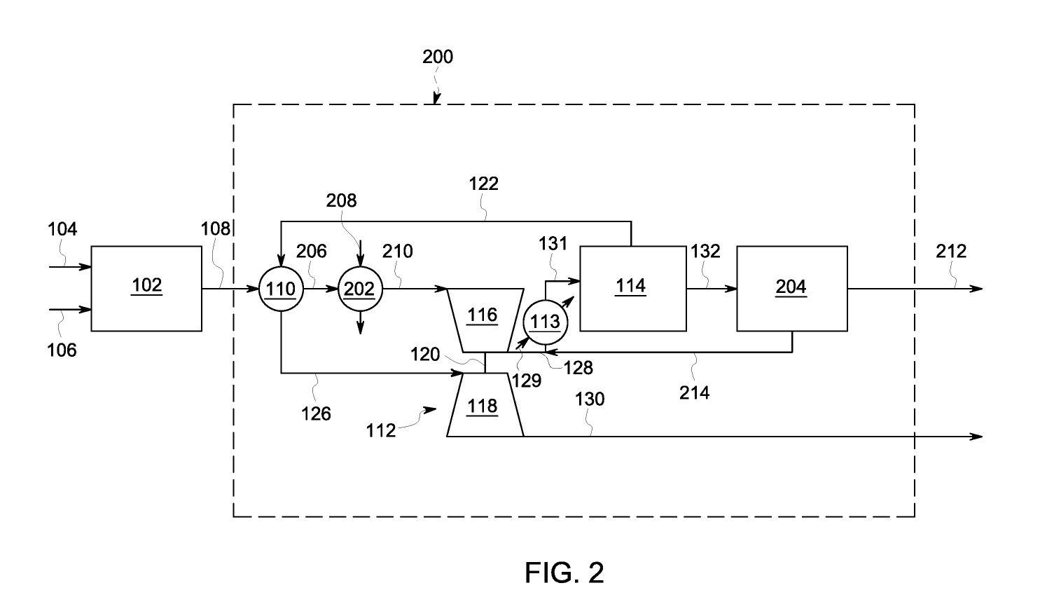

Carbon dioxide membrane unit 114 receives cooled compressed exhaust gas stream 131 from second heat exchanger 113. Carbon dioxide membrane unit 114 selectively removes carbon dioxide from cooled compressed exhaust gas stream 131 to produce a rich carbon dioxide stream 132 and lean carbon dioxide stream 122. Rich carbon dioxide stream 132 includes more carbon dioxide than lean carbon dioxide stream 122. In the exemplary embodiment, cooled compressed exhaust gas stream 131 enters carbon dioxide membrane unit 114 with about 20 percent by volume carbon dioxide. Rich carbon dioxide stream 132 leaves carbon dioxide membrane unit 114 with about 70 percent by volume carbon dioxide and lean carbon dioxide stream 122 leaves carbon dioxide membrane unit 114 with about 5 percent by volume carbon dioxide. Rich carbon dioxide gas 132 may be the final product or may be further refined as shown in FIG. 2.

Carbon dioxide membrane unit 114 includes a plurality of carbon dioxide selective membranes (not shown). Carbon dioxide passes through walls of the carbon dioxide selective membranes to an enclosed area (not shown) on the other side of the carbon dioxide selective membranes, while cooled compressed exhaust gas stream 131 continues through carbon dioxide membrane unit 114. The membrane(s) are carbon dioxide selective and thus continuously remove the carbon dioxide produced, including carbon dioxide which is optionally produced from carbon monoxide in catalyst portion(s), which can be added to carbon dioxide membrane unit 114 if required. The carbon dioxide selective membranes include any membrane material that is stable at the operating conditions and has the required carbon dioxide permeability and selectivity at the operating conditions. Possible membrane materials that are selective for carbon dioxide include certain inorganic and polymer materials, as well as combinations including at least one of these materials. Inorganic materials include microporous carbon, microporous silica., microporous titanosilicate, microporous mixed oxide, and zeolite materials, as well as material combinations including at least one of these materials.

FIG. 2 is a schematic diagram of an exemplary recovery system 200 for use in recovering carbon dioxide from exhaust gas stream 108. Recovery system 200 includes the equipment included in recovery system 100 with the addition of a third heat exchanger 202 and a cryogenic separation unit 204. Third heat exchanger 202 receives a first cooled exhaust gas stream 206 from first heat exchanger 110. Third heat exchanger 202 exchanges heat between cooled exhaust gas stream 206 and a cooling fluid 208. In the exemplary embodiment, cooling fluid 208 includes cooling water from a cooling water system (not shown). Cooling fluid 208 may be any fluid which enables recovery system 200 to function as described herein. First cooled exhaust gas stream 206 is reduced in temperature to produce a second cooled exhaust gas stream 210. Compressor 116 and carbon dioxide membrane unit 114 require the temperature of exhaust gas stream to be reduced to operate safely. As such, first heat exchanger 110 recovers energy from exhaust gas stream 108 and protects compressor 116 and carbon dioxide membrane unit 114. However, first heat exchanger 110 may not cool exhaust gas stream 108 to a safe operating temperature. To ensure that exhaust gas stream 108 is reduced to a safe operating temperature, third heat exchanger 202 further cools first cooled exhaust gas stream 206.

Cryogenic separation unit 204 separates rich carbon dioxide stream 132 into a liquid carbon dioxide product stream 212 and a recycle stream 214. Cryogenic separation unit 204 generally includes a cryogenic distillation column (not shown), a refrigeration unit (not shown), a plurality of heat exchangers (not shown), and a dehydration unit (not shown). The dehydration unit removes water from rich carbon dioxide stream 132. The refrigeration unit cools rich carbon dioxide stream 132 with the plurality of heat exchangers. The cryogenic distillation column separates the constituents of rich carbon dioxide stream 132 by boiling point. Liquid carbon dioxide product stream 212 may include a range of concentrations of carbon dioxide ranging from about 99 percent by volume to about 99.99 percent by volume. However, a substantial amount of carbon dioxide is not captured in liquid carbon dioxide product stream 212. Recycle stream 214 contains a substantial amount of carbon dioxide. Recycle stream 214 may include a range of concentrations of carbon dioxide ranging from about 50 percent by volume to about 90 percent by volume. In order to capture the carbon dioxide lost to recycle stream 214, recycle stream 214 is channeled to carbon dioxide membrane unit 114 for further separation.

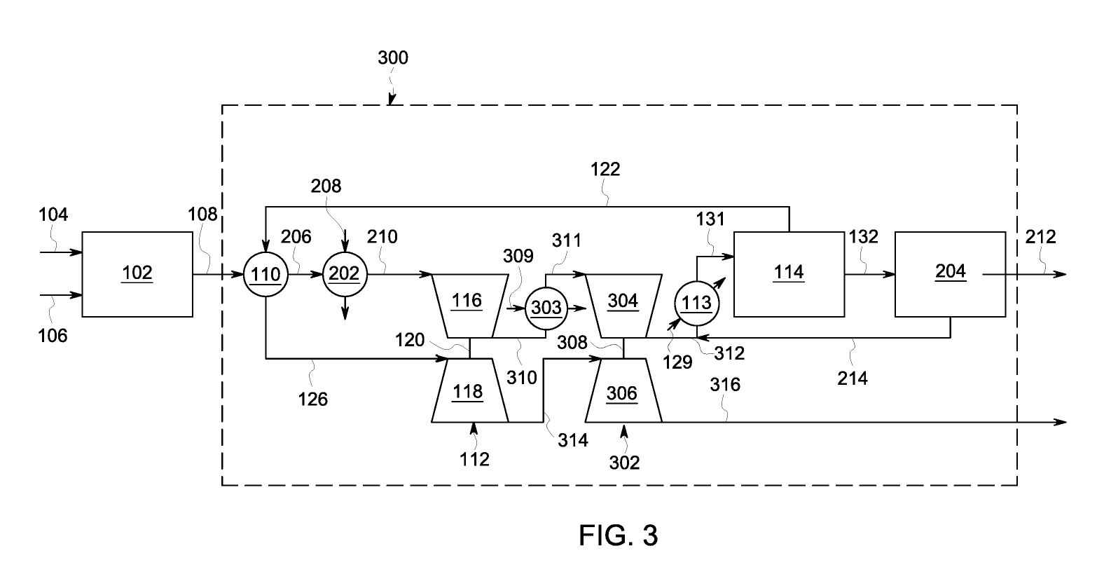

FIG. 3 is a schematic diagram of an exemplary recovery system 300 for use in recovering carbon dioxide from exhaust gas stream 108. Recovery system 300 includes the equipment included in recovery system 200 with the addition of a second turboexpander 302 and a fourth heat exchanger 303. Second turboexpander 302 includes a second compressor 304 drivingly coupled to a second turbine 306 by a second shaft 308. Fourth heat exchanger 303 receives a first compressed exhaust gas stream 310 from compressor 116. Fourth heat exchanger 303 exchanges heat between first compressed exhaust gas stream 310 and a cooling fluid 309. In the exemplary embodiment, cooling fluid 309 includes cooling water from a cooling water system (not shown). Cooling fluid 309 may be any fluid which enables recovery system 300 to function as described herein. First compressed exhaust gas stream 310 is reduced in temperature to produce a second compressed exhaust gas stream 311. During compression, the heat of compression from compressor 116 increases the temperature of second cooled exhaust gas stream 210. Second compressor 304 requires the temperature of first compressed exhaust gas stream 310 to be reduced to operate safely. As such, fourth heat exchanger 303 cools first compressed exhaust gas stream 310 to protect second compressor 304. Second compressor 304 receives second compressed exhaust gas stream 311 from fourth heat exchanger 303. Second compressor 304 further compresses second compressed exhaust gas stream 311 to produce a third compressed exhaust gas stream 312.

Second turbine 306 receives a first expanded lean carbon dioxide stream 314 from turbine 118. Second turbine 306 expands first expanded lean carbon dioxide stream 314 and rotates second shaft 308. Second shaft 308, in turn, rotates second compressor 304 and compresses second compressed exhaust gas stream 311. As such, second turbine 306 recovers more energy recovered from exhaust gas stream 108 and uses the recovered energy to power second compressor 304. Using recovered energy to power second compressor 304 saves energy and reduces the energy consumption per unit of carbon dioxide recovered by recovery system 300. Second turbine 306 produces a second expanded lean carbon dioxide stream 316 which is discharged to the atmosphere. Recovery system 300 is not limited to two turboexpanders. Recovery system 300 may include any number of turboexpanders that enable recovery system 300 to function as described herein.

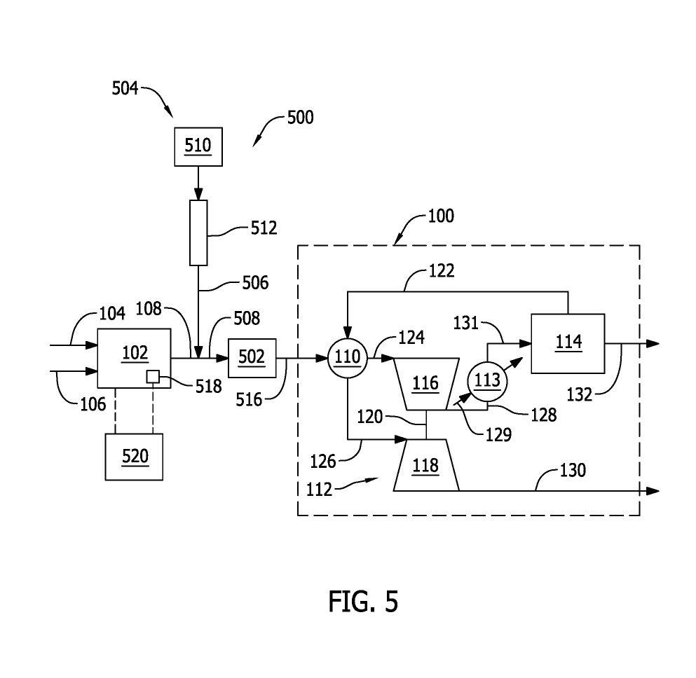

FIG. 5 is a schematic diagram of an exemplary scavenging system 500 for use in scavenging oxygen from exhaust gas stream 108. System 500 includes exemplary recovery system 100, the components and operation of which are described above in at least the description of FIG. 1. In the exemplary embodiment, scavenging system 500 includes a first catalytic converter unit 502 that receives exhaust gas stream 108 from power production unit 102. As noted above, exhaust gas stream 108 generally includes about 12 percent by volume carbon dioxide. In addition, exhaust gas stream 108 also includes oxygen of less than about 1 percent by volume. Scavenging system 500 is operable to reduce a concentration of oxygen in exhaust gas stream 108, and thus in rich carbon dioxide stream 132.

In one embodiment, first catalytic converter unit 502 is a three-way catalytic converter that reduces a concentration of carbon monoxide, nitrous oxides, and volatile organic compounds in exhaust gas stream 108. More specifically, first catalytic converter unit 502 contains a catalyst that induces combustion of methane and oxygen to produce carbon dioxide when exhaust gas stream 108 is channeled through first catalytic converter unit 502, for example. As such, the concentration of oxygen in exhaust gas stream 108 is reduced.

In some embodiments, it is desirable to reduce the concentration of elemental oxygen in exhaust gas stream 108 to less than a predetermined threshold, such as when rich carbon dioxide stream 132 is intended for implementation in industrial applications. For example, the presence of oxygen in exhaust gas stream 108 increases the corrosiveness of carbon dioxide and water mixtures, and can facilitate growth of biological systems in underground reservoirs, for example, which may cause operational issues with enhanced oil recovery.

In one embodiment, the predetermined threshold is about 100 parts per million (ppm). In another embodiment, the predetermined threshold is less than about 50 ppm. Moreover, the hydrocarbon content of exhaust gas stream 108 may be insufficient to reduce the concentration of oxygen in exhaust gas stream 108 to less than the predetermined threshold. In the exemplary embodiment, scavenging system 500 further includes a hydrocarbon injection unit 504 that channels a hydrocarbon stream 506 for injection into exhaust gas stream 108 upstream from first catalytic converter unit 502. As such, a mixed exhaust stream 508 formed from exhaust gas stream 108 and hydrocarbon stream 506 is channeled into first catalytic converter unit 502. Hydrocarbons from hydrocarbon stream 506 react with oxygen from exhaust gas stream 108 within first catalytic converter unit 502 to produce carbon dioxide. As such, the concentration of oxygen in exhaust gas stream 108 is reduced.

In the exemplary embodiment, hydrocarbon injection unit 504 includes a source 510 of hydrocarbons and a nozzle 512 in flow communication with source 510 of hydrocarbons. In one embodiment, source 510 of hydrocarbons contains methane, such that hydrocarbon injection unit 504 channels hydrocarbon stream 506 that includes methane for injection into exhaust gas stream 108. Moreover, nozzle 512 is operable to distribute the hydrocarbons in exhaust gas stream 108 substantially uniformly. As such, the hydrocarbons are positioned for reacting with the oxygen in exhaust gas stream 108 when channeled across first catalytic converter unit 502. In operation, hydrocarbon injection unit 504 injects hydrocarbon stream 506 into exhaust gas stream 108 in an amount such that a hydrocarbon-oxygen ratio in mixed exhaust stream 508 is at least stoichiometric to facilitate reducing the concentration of oxygen to less than the predetermined threshold.

Scavenging system 500 also includes a lambda sensor 518 and a controller 520 in communication with lambda sensor 518. Lambda sensor 518 monitors the air-fuel ratio within power production unit 102, and controller 520 controls the air-fuel ratio within power production unit 102 such that exhaust gas stream 108 contains a predetermined concentration of oxygen. In addition, a catalyst performance map is integrated into the control scheme implemented by controller 520 to account for the formulation of the catalyst in first catalytic converter unit 502 and the fuel composition of that used on power production unit 102.

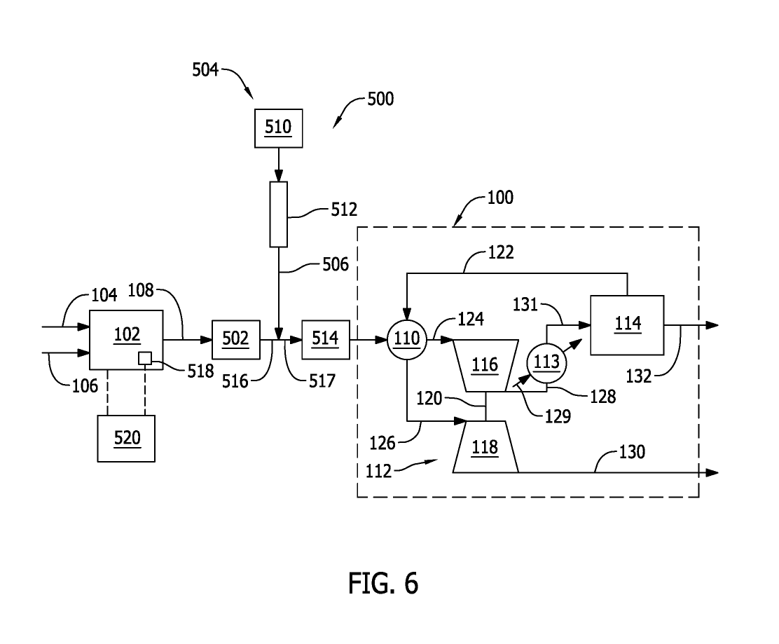

FIG. 6 is a schematic diagram of an alternative scavenging system 500 for use in scavenging oxygen from exhaust gas stream 108. In the exemplary embodiment, scavenging system 500 further includes a second catalytic converter unit 514 positioned downstream from first catalytic converter unit 502. Second catalytic converter unit 514 receives a treated exhaust gas stream 516 discharged from first catalytic converter unit 502, and is operable to further reduce a concentration of oxygen in treated exhaust gas stream 516. Second catalytic converter unit 514 contains a catalyst designed to mitigate the oxygen concentration in treated exhaust gas stream 516. For example, second catalytic converter unit 514 contains a catalyst that induces combustion of methane and oxygen to produce carbon dioxide when treated exhaust stream 516 is channeled through second catalytic converter unit 514.

In addition, hydrocarbon injection unit 504 channels hydrocarbon stream 506 for injection into treated exhaust gas stream 516 downstream from first catalytic converter unit 502 and upstream from second catalytic converter unit 514. As such, a mixed exhaust stream 517 formed from treated exhaust gas stream 516 and hydrocarbon stream 506 is channeled into second catalytic converter unit 514. Hydrocarbons from hydrocarbon stream 506 react with oxygen from treated exhaust gas stream 516 within second catalytic converter unit 514 to produce carbon dioxide. As such, the concentration of oxygen in treated exhaust stream 516 is reduced.

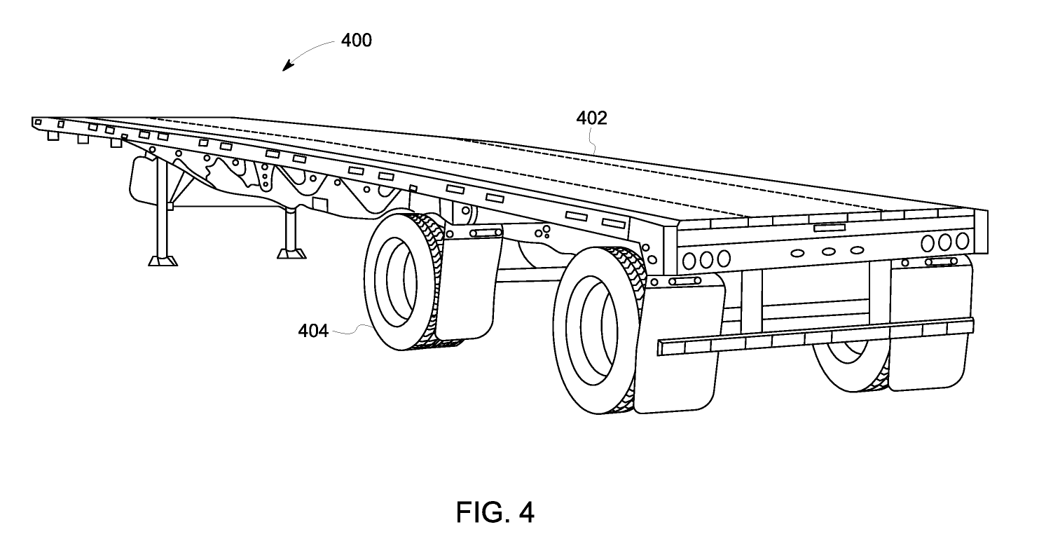

Recovery systems 100, 200, and 300, and scavenging system 500 may be permanently installed as a unit at a power production facility. In an alternative embodiment, recovery systems 100, 200, and 300, and scavenging system 500 are mobile recovery systems disposed on a transport apparatus 400. FIG. 4 is a perspective view of transport apparatus 400. In the exemplary embodiment, transport apparatus 400 is a trailer. Transport apparatus 400 includes a flatbed 402 and a plurality of wheels 404 configured to transport flatbed 402 and recovery systems 100, 200, or 300, or scavenging system 500. In an alternative embodiment, transport apparatus 400 includes an enclosed trailer or any other transport apparatus that enables recovery systems 100, 200, or 300, or scavenging system 500 to operate as described herein. Mobile recovery systems 100, 200, and 300, and mobile scavenging system 500 are transported to sites with mobile power production units such as, but not limited to, oil wells and constructions sites. Mobile recovery systems 100, 200, and 300, and mobile scavenging system 500 produce rich carbon dioxide stream 132 as described herein for use on the oil wells and construction sites.

The above-described carbon dioxide recovery system provides an efficient method for removing carbon dioxide from an exhaust gas stream. Specifically, the turboexpander compresses the exhaust gas stream and the lean carbon dioxide stream drives the turboexpander. Additionally, the carbon dioxide membrane unit selectively removes carbon dioxide from the compressed exhaust gas stream. Finally, the first heat exchanger transfers energy from the exhaust gas stream to the lean carbon dioxide stream. Using the energy recovered from the exhaust gas stream by the lean carbon dioxide stream to drive the compression needed to separate carbon dioxide from the exhaust gas stream reduces the energy consumption per kg (lb) of carbon dioxide recovered of the process. As such, the systems and methods described herein embody the process changes and equipment for use in recovering carbon dioxide from a carbon dioxide-rich gas stream using a carbon dioxide membrane and a turboexpander to reduce the energy consumption per unit of carbon dioxide recovered of the process.

An exemplary technical effect of the system and methods described herein includes at least one of: (a) recovering carbon dioxide from an exhaust gas stream; (b) recovering heat from an exhaust gas stream; (c) powering a compressor with a turbine; and (d) decreasing the energy consumption per kg (lb) of carbon dioxide recovered.

Exemplary embodiments of carbon dioxide recovery system and related components are described above in detail. The system is not limited to the specific embodiments described herein, but rather, components of systems and/or steps of the methods may be utilized independently and separately from other components and/or steps described herein. For example, the configuration of components described herein may also be used in combination with other processes, and is not limited to practice with only power generation plants and related methods as described herein. Rather, the exemplary embodiment can be implemented and utilized in connection with many applications where recovering carbon dioxide from a gas stream is desired.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An oxygen scavenging system comprising:
a first catalytic converter unit configured to receive an exhaust stream from a power production unit, wherein the exhaust stream includes oxygen; and
a hydrocarbon injection unit configured to channel a hydrocarbon stream for injection into the exhaust stream upstream from said first catalytic converter unit such that hydrocarbons from the hydrocarbon stream react with the oxygen from the exhaust stream within said first catalytic converter unit.

2. The system in accordance with claim 1, wherein said hydrocarbon injection unit is configured to channel the hydrocarbon stream that includes methane.

3. The system in accordance with claim 1, wherein said hydrocarbon injection unit comprises a nozzle configured to distribute the hydrocarbons in the exhaust stream substantially uniformly.

4. The system in accordance with claim 1, wherein said first catalytic converter unit is a three-way catalytic converter configured to reduce a concentration of carbon monoxide, nitrous oxides, and volatile organic compounds in the exhaust stream.

5. The system in accordance with claim 1 further comprising a transport apparatus configured to receive said first catalytic converter unit and said hydrocarbon injection unit thereon.

6. The system in accordance with claim 5, wherein said transport apparatus is a trailer.

7. The system in accordance with claim 1 further comprising:
a lambda sensor configured monitor an air-fuel ratio within said power production unit; and
a controller in communication with said lambda sensor, wherein said controller is configured to control the air-fuel ratio within said power production unit such that the exhaust stream contains a predetermined concentration of oxygen.

8. A method of reducing oxygen concentration in an exhaust stream, said method comprising:
channeling an exhaust stream towards a first catalytic converter unit, wherein the exhaust stream includes oxygen;
injecting a hydrocarbon stream into the exhaust stream upstream from the first catalytic converter unit such that a mixed exhaust stream is formed; and
channeling the mixed exhaust stream into the first catalytic converter unit such that hydrocarbons from the hydrocarbon stream react with the oxygen from the exhaust stream.

9. The method in accordance with claim 8, wherein injecting a hydrocarbon stream comprises injecting the hydrocarbon stream in an amount such that a hydrocarbon-oxygen ratio in the mixed exhaust stream is at least stoichiometric.

10. The method in accordance with claim 8, wherein injecting a hydrocarbon stream comprises injecting the hydrocarbon stream that includes methane.

11. The method in accordance with claim 8, wherein injecting a hydrocarbon stream comprises distributing the hydrocarbons in the exhaust stream substantially uniformly.

12. The method in accordance with claim 8 further comprising channeling a treated exhaust stream discharged from the first catalytic converter unit towards a second catalytic converter unit.

13. The method in accordance with claim 8 further comprising:
monitoring an air-fuel ratio within a power production unit, wherein the power production unit is configured to discharge the exhaust stream therefrom; and
controlling the air-fuel ratio within the power production unit such that the exhaust stream contains a predetermined concentration of oxygen.

14. An oxygen scavenging system comprising:
a first catalytic converter unit configured to receive an exhaust stream from a power production unit, wherein the exhaust stream includes oxygen;
a second catalytic converter unit positioned downstream from said first catalytic converter unit, wherein said second catalytic converter unit is configured to receive a treated exhaust stream discharged from said first catalytic converter unit; and
a hydrocarbon injection unit configured to channel a hydrocarbon stream for injection into the treated exhaust stream upstream from said second catalytic converter unit such that hydrocarbons from the hydrocarbon stream react with the oxygen from the treated exhaust stream within said second catalytic converter unit.

15. The system in accordance with claim 14, wherein said hydrocarbon injection unit is configured to channel the hydrocarbon stream that includes methane.

16. The system in accordance with claim 14, wherein said hydrocarbon injection unit comprises a nozzle configured to distribute the hydrocarbons in the exhaust stream substantially uniformly.

17. The system in accordance with claim 14, wherein said first catalytic converter unit is a three-way catalytic converter configured to reduce a concentration of carbon monoxide, nitrous oxides, and volatile organic compounds in the exhaust stream.

18. The system in accordance with claim 14 further comprising a transport apparatus configured to receive said first catalytic converter unit, said second catalytic converter unit, and said hydrocarbon injection unit thereon.

19. The system in accordance with claim 14, wherein said second catalytic converter unit contains a catalyst that induces combustion of carbon monoxide and oxygen to produce carbon dioxide.

20. The system in accordance with claim 14, wherein said scavenging system further comprises:
a lambda sensor configured monitor an air-fuel ratio within said power production unit; and
a controller in communication with said lambda sensor, wherein said controller is configured to control the air-fuel ratio within said power production unit such that the exhaust stream contains a predetermined concentration of oxygen.
